(19) United States
(12) Patent Application Publication
(10) Pub. No.: US 2010/0028583 A1
(43) Pub. Date: Feb. 4, 2010

(54) PIPES CONTAINING NANOCLAYS AND METHOD FOR THEIR MANUFACTURE

(75) Inventors: Robert B. Fish, JR., Parkersburg, WV (US); Rolando Umali Pagilagan, Parkersburg, WV (US); Steven A. Mestemacher, Parkersburg, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilimington, DE (US)

(21) Appl. No.: 12/446,908

(22) PCT Filed: Sep. 17, 2007
(86) PCT No.: PCT/US2007/020338

§ 371 Date: Apr. 23, 2009

Related U.S. Application Data
(60) Provisional application No. 60/854,981, filed on Oct. 27, 2006.

(51) Int. Cl. B32B 1/08; B29D 23/00

(52) U.S. Cl. 428/36.91; 264/209.1

(57) ABSTRACT

A pipe or comprising a melt-mixed blend of polyamide and incompatible polyolefin and a compatibilizing agent where the polyamide exists as a discontinuous phase that is dispersed in a polyolefin matrix and wherein nanoclay is exfoliated in the polyamide phase. The pipe has enhanced resistance to the permeation of hydrocarbons relative to polyethylene. A method for making a pipe having enhanced resistance to the permeation of hydrocarbons.

### FIELD OF THE INVENTION

The present invention relates to pipes comprising a melt-mixed blend of polyamide and incompatible polyolefin and a compatibilizing agent where the polyamide exists as a discontinuous phase that is dispersed in a polyolefin matrix and wherein nanoclay is exfoliated in the polyamide phase. The pipe has enhanced resistance to the permeation of hydrocarbons relative to polyethylene.

### BACKGROUND OF THE INVENTION

There are a wide variety of materials, including solids, liquids, and gases that need to be transported through pipes under a broad range of conditions. It is often important that the pipes used have a low permeability to and are physically and chemically resistant to the substances being transported. Metal pipes are generally very impermeable to most substances, but unless expensive alloys are used, they can be susceptible to corrosion. Metal pipes can be heavy and difficult and unwieldy to manipulate and store. Polymeric pipes are often a more inexpensive, lighter, and easier to handle alternative and corrosion- and chemical-resistant polymeric materials are available. However, many polymeric pipes are permeable to substances such as hydrocarbons to an undesirable degree. This is a particular issue for many applications in the oil and gas industry where large volumes of liquid and gaseous hydrocarbons, water, salt water, and other volatile and/or corrosive substances are transported, sometimes over great distances.

Polyethylene pipes are often desirable for many applications, as they are resistant to abrasion, water, and some chemical corrosion. They are also conveniently formed into long continuous tubes that require few if any joint connections. This is important as leaks are more likely to occur at or near joints.

It would be desirable to obtain thermoplastic polymeric pipes that have good permeation resistance to hydrocarbons. One approach to reducing the permeability of thermoplastic polymers is to compound them with fillers or other additives. Examples of fillers include metals, metal oxides, ceramics, minerals, clays, and fibers. The added fillers can serve as barriers that can enhance the permeation resistance of the polymeric material relative to the unfilled material, but in order to obtain the desired effect, they must often be added at high levels, which can negatively impact the mechanical or chemical properties of the of the material.

Nanoclays are often very effective in reducing the permeability of thermoplastic polymeric materials, but they can be difficult to exfoliate and disperse, particularly in non-polar polymers such as polyethylene and other polyolefins.

Additionally, undesirably high loadings of nanoclays are often required for optimal permeation resistance. Excessive loading can make it harder to exfoliate and disperse the nanoclays or can be detrimental to the mechanical and chemical properties of the resulting thermoplastic composition.

It would be particularly desirable to obtain pipes made from nanoclay-containing polymeric compositions that had good hydrocarbon permeation resistance while maintaining good mechanical properties.

JP 2004-277740 discloses a composition containing polyamide and polyolefins where the polyamide serves as a carrier for nanoclays. US patent application publication 2004/0225066 discloses polyamide and polyolefin blends with a polyamide matrix and containing nanofillers. US patent application publication 2004/0118468 discloses polymeric pipes and liners suitable for transporting oil and gas materials and made from blends of polyolefins and polyamides. US patent application publication 2004/0181162 discloses polymeric pipes made from blends of polyolefins and vinyl alcohol polymers. US patent application publication 2005/0048239 discloses polymeric pipes and liners and fuel lines made from blends of fluoropolymers and polyamides.

### SUMMARY OF THE INVENTION

Disclosed and claimed herein are pipes comprising a composition comprising a melt-mixed blend of:

(a) at least one polyolefin;

(b) at least one polyamide incompatible with said at least one polyolefin (a);

(c) at least one nanoclay exfoliated in the polyamides (b); and

(d) at least one alkylcarboxyl-substituted polyolefin compatibilizer;

wherein the polyolefins (a) are in a continuous matrix phase and the polyamides (b) are present in a discontinuous distributed phase in the form of a multitude of thin, substantially two-dimensional, parallel, and overlapping layers of material embedded in the continuous phase, and where the nanoclays (c) are present in the polyamides (b) and further wherein at least a portion of the compatibilizer (d) is present between said layers and promotes adhesion therebetween

Further disclosed and claimed herein is a method for forming pipes, comprising the steps of
(i) exfoliating (a) least one nanoclay in (b) at least one polyamide to form blend A;
(ii) melt-blending (c) at least one polyolefin, (d) at least one alkylcarboxyl-substituted polyolefin compatibilizer; and blend A to form melt blend B;
(iii) extruding melt blend B into a molten extrudate having the form of a pipe such that the extrudate is not substantially stretched; and
(iv) cooling the extrudate sufficiently to allow it to solidify into a pipe,
   wherein the solidified extrudate is not substantially stretched, and such that in the pipe the polyolefins (c) are in a continuous matrix phase and the polyamides (b) are present in a discontinuous distributed phase in the form of a multitude of thin, substantially two-dimensional, parallel, and overlapping layers of material embedded in the continuous phase, and where the nanoclays (a) are present in the polyamides (b) and further wherein at least a portion of the compatibilizer (d) is present between said layers and promotes adhesion therebetween.

### DETAILED DESCRIPTION OF THE INVENTION

As used herein, the term “pipe” refers to a hollow, elongated, often cylindrical conduit that is typically used to contain substances that can include fluids, hydrocarbon effluent, finely divided solids, or gases during transport. The pipes may have a circular or roughly circular (e.g. oval) cross-section. However more generally the pipes may be shaped into seemingly limitless geometries so long as they define a passageway therethrough. For example, suitable shapes may include polygonal shapes and may even incorporate more that one shape along the length thereof. The pipes may further be joined together by suitable means to form T-sections, branches, and the like.

As used herein when referring to a polymer, the term “particle” refers to the physical form of the bulk polymer and can be a pellet, cube, flake, powder, or other form known to those skilled in the art.

For the purposes of this invention, “incompatible polymers” mean polymeric materials that have substantially no mutual miscibility in the melt form.

The pipe of the present invention comprises a polymeric composition that comprises a melt-mixed blend of at least one polyolefin, at least one polyamide that is incompatible with the one or more polyolefins, at least one nanoclay that is exfoliated in the polyamide, and at least one polymeric compatibilizing agent that serves to adhere together domains of the incompatible polymers, such that the polyamide/nanoclay portion exists in a discontinuous phase that is distributed in the polyolefin continuous phase. The discontinuous polyamide/nanoclay phase exists in a laminar configuration, meaning that it comprises a multitude of domains in the form of thin, substantially two-dimensional, parallel, and overlapping layers of material that are embedded in the continuous polyolefin phase. The presence of these domains improves the barrier properties of the unmodified polyolefin by creating an extended maze through which hydrocarbons or other substances must pass if they are to permeate or diffuse through the wall of the pipe.

It is believed that at least some of the polymeric compatibilizer is concentrated between adjacent layers of incompatible polymer and is joined partially with one layer and partially with an adjacent layer, thus adhering the layers together. Without the compatibilizer, pipes formed from heterogeneous melts of incompatible polymer have poor mechanical properties and, generally, cannot even be easy formed by extrusion or molding as unitary articles.

The presence of the laminar configuration of the discontinuous polyamide/nanoclay phase means that smaller amounts of nanoclay are required to achieve a given degree of permeation resistance than would be obtained from a homogeneous blend of polyolefin, polyamide, and nanoclay. Homogeneous well-mixed blends are only partially effective until significant quantities (e.g., about 3 to 6 weight percent) of nanoclay are present. The manufacture of pipes having multiple coextruded layers of different materials would require additional investment for additional extruders for each polymer type as well as some sort of “adhesive layer” to bind the incompatible materials. The current invention bypasses these traditional and more costly approaches by using a single step extrusion in a manner that allows for significantly reduced amounts of nanoclay.

The composition used in the present invention is prepared by making a blend of polyamide-nanoclay particles by exfoliating and dispersing at least one nanoclay in at least one polyamide The polyamide/nanoclay blend preferably comprises about 85 to about 95 weight percent polyamide and about 15 to about 5 weight percent nanoclay, or more preferably comprises about 90 to about 95 weight percent polyamide and about 10 to about 5 weight percent nanoclay, where the weight percentages are based on the total weight of polyamide and nanoclay.

The particles of the components are mixed and heated in such a way that a heterogeneous melt of material is obtained. The melt is then formed into a pipe using any method known in the art.

In one embodiment, the polyamide/nanoclay blend is then cube-blended with polyolefin particles and compatibilizer particles. The cube blend is formed by tumbling, stirring, or otherwise uniformly mixing the particles in solid form at a temperature below the melting point of any component. The cube blend may be formed using any method known in the art, including by tumbling the components in a drum, mixing them in an orbital or twin-cone blender, feeding them from separate loss-in-weight feeders into a common vessel, and other techniques. The particles of the components are preferably similar in size and shape to avoid segregation of the components in the cube blend. The resulting cube blend is heated to form a heterogeneous melt of material which is then formed in such a way that it is stretched to yield an elongated discontinuous phase of polyamide/nanoclay.

In another embodiment, the polyamide/nanoclay blend, polyolefin, and compatibilizer particles are combined in molten or softened form such that the melt-blended composition retains the heterogeneous character necessary for the formation of the laminar structure.

In a further embodiment, the component polymer particles are combined at a temperature at which either the polyamide/nanoclay or the polyolefin is not softened or molten while the other is and then heating the combination further.

It will readily occur to those skilled in the art that there are additional ways to bring the required ingredients together to form said laminar structure, all without departing from the spirit of this invention.

The component particles should, as a general rule, be of a size such that the molten blend of incompatible polymers, when introduced to some melt stretching means, such as extrusion die lips, exhibits the heterogeneity preferred for the practice of the invention. When the particles, especially particles of the polyamide/nanoclay, are of too small a size, the melted blend, even though not excessively mixed, tends to function as a homogeneous composition because the domains of material making up the discontinuous polymer phase are so small. When the particles, especially particles of the polyamide/nanoclay blend, are of too large a size, the melted blend tends to form into pipes having a marbleized structure rather than a laminar structure, the large domains of the materials that would make up the discontinuous phase extending to opposite boundaries of the pipe and causing disruption of the material that would make up the continuous phase. The particles are preferably generally regular in shape, such as cubical or spherical or the like. The particles may, however, be irregular; and they may have one dimension substantially greater than another dimension such as would be the case, for example, when flakes of material are used.

In one embodiment of the present invention, the polyolefin and polyamide are selected such that they have melting points and melt viscosities that lead to the ready formation of a pipe having the laminar structure of the invention without the need for significant post-extrusion stretching of the melt. It is well known in the art that polyamides having a variety of melting points are available and that in the case of polyamides formed from two or more comonomers, the melting point of the polyamide can be varied by varying the relative amounts of the comonomers. For example, polyamide 6 has a melting point of about 221° C.; polyamide 6,6 has a melting point of about 264° C.; and polyamide 6,6/6 (65/35 weight percent) has a melting point of about 194° C.

It is additionally well known that melt viscosities of polyamides and polyolefins typically decrease as the temperature of the melt increases. The use of a polyamide having too high a melting point may require the use of processing temperatures at which the polyolefin component has a relatively low melt viscosity and the limited shear generated in many methods of forming pipes from molten polymeric materials may be insufficient to form an optimal laminar structure. Similarly, the use of a polyamide having too low a melting point may require the use of processing temperatures at which the polyolefin component has a relatively high melt viscosity and shear generated in many methods of forming pipes may result in a pipe in which the polyamide component forms well-dispersed spherical structures rather than an optimal laminar structure. Additionally, as will be understood by those skilled in the art, the operating temperature used in the pipe formation apparatus may be varied to form the pipes having the laminar structure of the invention.

The process of forming the pipes of the invention involves the use of normal pipe-forming equipment that is well known to those skilled in the art. That equipment may include a single screw extruder equipped with a pipe die. The extruder may be followed with a vacuum cooling bath and a variable speed puller. The puller may be followed by some appropriate means of collecting the finished pipe. One such means may be a coiling apparatus and another may be a means for cutting the pipe into the desired length. Numerous companies make suitable extrusion equipment.

Commercial vacuum cooling baths, variable speed pullers, and cutoff devices are available from The Conair Group, Inc., Pittsburgh, Pa.

The pipes of the present invention are preferably made substantially without stretch orientation or melt stretching. By “substantially without stretch orientation or melt orientation,” it is meant that the stretching in the gap between the extruder and the vacuum forming box is limited to that required to prevent the polymer melt from sagging and that no appreciable externally applied stretching occurs thereafter.

In processes such as blow molding (such as to make bottles, etc.) and the formation of extruded and drawn films, the molten polymer is typical subjected to substantial amounts of biaxial stretching.

The polyamide/nanoclay blend used in this invention is preferably present in about 2 to about 40, or more preferably about 3 to about 20, or yet more preferably about 5 to about 15 weight percent based on the total amount of polyamide/nanoclay blend, compatibilizer, and polyolefin in the composition.

The one or more compatibilizing agents of the composition used in this invention are preferably present in about 0.25 to about 12, or preferably about 0.25 to about 6, or yet more preferably about 0.5 to about 4 weight percent based on the total amount of polyamide/nanoclay blend, compatibilizer, and polyolefin in the composition.

The one or more polyolefins of the composition used in this invention are preferably present in about 59 to about 97.75, or more preferably about 79 to 96.75, or yet more preferably about 84 to about 94.5 weight percent based on the total amount of polyamide/nanoclay blend, compatibilizer, and polyolefin in the composition.

Any of the components can be used to introduce inert fillers into the composition provided only that the fillers are not of a kind or in an amount that would interfere with formation of the layered construction or with the desired or required properties of the composition. Amounts of plasticizers, opacifiers, colorants, lubricating agents, heat stabilizers, oxidation stabilizers, and the like that are ordinarily used in structural polymeric materials can be used herein. The amount of such filler is not included in the calculation of amounts of incompatible polymers and compatibilizers.

The polyolefins used in the composition of the invention include polyethylene, polypropylene, polybutylene, copolymers of those materials, cross-linked polyolefins, and the like. Polyethylene is preferred and may be high, medium, or low density or cross-linked.

When used herein, the term “polyamides” refers to both homopolymers and copolymers. Polyamides are well known and are made by reacting carboxylic acids or their reactive equivalents with primary amines and/or lactams under well-known conditions. Lactams and aminoacids may also be reacted to yield polyamides. Examples of carboxylic acids used in polyamide preparation are adipic acid, suberic acid, sebacic acid, azelaic acid, malonic acid, glutaric acid, pimelic acid, isophthalic acid, terephthalic acid, and the like. Examples of primary diamines are tetramethylenediamine, pentamethylenedia mine, hexamethylenediamine, octamethylenediamine, and the like. Exemplary polyamides include poly(pentamethylene adipamide), poly(hexamethylene adipamide), poly(hexamethylene sebacamide); polyamides obtained from lactams such as caprolactams and from amino acids such as 11-aminoundecanoic acid, and the like. Copolyamides are also suitable. Preferred polyamides have melting points in the range of 150° C. to 250° C. and even more preferred in the range of 180° C. to 225° C., and include such polymers as polycaproamide, poly(11-aminoundecanoamide), polydodecanoamide, poly(hexamethylene sebacamide), poly(hexamethylene dodecanoamide), and copolymers of poly(hexamethylene adipamide) with polycaproamide. Also preferred are amorphous polyamide copolymers that do not have clearly-defined melting points, but which are derived in part from aromatic monomers such as isophthalic acid.

The polyamides used in the composition used in the present invention should be melt extrudable, and preferably have a number average molecular weight of at least 5000. Examples of polyamides include those made by condensation of equimolar amounts of at least one saturated dicarboxylic acid containing 4 to 14 carbon atoms with at least one diamine containing 4 to 14 carbon atoms. Excess diamine, however can be used to provide an excess of amine end groups over carboxyl end groups in the polyamide. Specific examples include polyhexamethylene adipamide (66 nylon), polyhexamethylene azelaamide (69 nylon), polyhexamethylene sebacamide (610 nylon), polyhexamethylene dodecanoamide (612 nylon), polycaprolactam (6 nylon), and their copolymers. Semi-aromatic polyamides that are melt extrudable can also be used in the melt-mixed blends of the present invention.

The compatibilizer used in the composition used in this invention is an alkylcarboxyl-substituted polyolefin, which is a polyolefin that has carboxylic moieties attached thereto, either on the polyolefin backbone itself or on side chains. By “carboxylic moiety” is meant carboxylic groups from the group consisting of acids, esters, anhydrides, and salts. Carboxylic salts are neutralized carboxylic acids and a compatibilizer, which includes carboxylic salts as a carboxylic moiety also, includes the carboxylic acid of that salt. Such compatibilizers are termed ionomeric polymers.

Compatibilizers can be prepared by direct synthesis or by grafting. An example of direct synthesis is the polymerization of an α-olefin with an olefinic monomer having a carboxylic moiety; and an example of grafting is the addition of a monomer having a carboxylic moiety to a polyolefin backbone. In the compatibilizer made by grafting, the polyolefin is polyethylene or a copolymer of ethylene and at least one α-olefin of 3-8 carbon atoms such as propylene, and the like, or a copolymer including at least one α-olefin of 3-8 carbon atoms and a diolefin, such as 1,4-hexadiene, and the like. The polyolefin is reacted with an unsaturated carboxylic acid, anhydride, or ester monomer to obtain the grafted polymer. Representative eligible acids, anhydrides, and esters include: methacrylic acid; acrylic acid; ethacrylic acid; glycidyl methacrylate; 2-hydroxy ethylacrylate; 2-hydroxy ethyl methacrylate; diethyl maleate; monoethyl maleate; di-n-butyl maleate; maleic anhydride; maleic acid; fumaric acid; itaconic acid; monoesters of such dicarboxylic acids; dodecenyl succinic anhydride; 5-norbornene-2,3-anhydride; nadic anhydride (3,6-endomethylene-1,2,3,6-tetrahydrophthalic anhydride); and the like. Generally, the graft polymer will have from about 0.01 to 20, preferably about 0.1 to 10, and most preferably about 0.2 to 5, weight percent graft monomer. Grafted polymers are described in greater detail in U.S. Pat. Nos. 4,026,967 and 3,953,655.

In the compatibilizer made by direct synthesis, the polymeric material is a copolymer of an α-olefin of 2-10 carbon atoms and an α,β-ethylenically unsaturated carboxylic acid, ester, anhydride, or salt having 1 or 2 carboxylic moieties. The directly synthesized compatibilizer is made up of at least 75 mole percent of the olefin component and from about 0.2 to 25 mole percent of the carboxylic component.

Ionomeric compatibilizers are preferably made from directly synthesized compatibilizer and are preferably made up of about 90 to 99 mol percent olefin and about 1 to 10 mol percent α,β-ethylenically unsaturated monomer having carboxylic moieties wherein the moieties are considered as acid equivalents and are neutralized with metal ions having valences of 1 to 3, inclusive, where the carboxylic acid equivalent is monocarboxylic and are neutralized with metal ions having a valence of 1 where the carboxylic acid equivalent is dicarboxylic. To control the degree of neutralization, metal ions are present in an amount sufficient to neutralize at least 10 percent of the carboxyl moieties. Representative eligible α-olefins and unsaturated carboxylic acid, anhydride, and ester monomers are those previously herein described. Ionomeric polymers are described in greater detail in U.S. Pat. No. 3,264,272.

Preferred compatibilizers are polyolefins grafted with a dicarboxylic acid or dicarboxylic acid derivative such as an anhydride or ester or diester.

The nanoclays used in the present invention are layered silicates, preferably an aluminum or magnesium silicates. The nanoclays will generally be platelet shaped and have a diameter in the range of about 10 to about 5000 nm. The layer thickness is less than about 2 nm. The nanoclays will preferably be swellable clays, meaning that the clays have the ability to absorb water or other polar organic liquids such as methanol and ethanol between the layers. When the liquids are absorbed, the nanoclays swell. At least one dimension of the nanoclay particles will be less than about 20 nm, and preferably less than about 5 nm. The nanoclays contain interlayer cations such as alkali and alkaline earth metal cations. Preferred cations include sodium and calcium ions. The nanoclays are used in an untreated form, meaning that they are not treated with an agent, such as a surfactant, to exchange metal cations present between the layers with organic cations such as ammonium or other onium ions.

Preferred nanoclays include smectite clays such as montmorillonite, hectorite, saponite, beidellite, nontronite, bentonite, saponite, and the like. Both natural and synthetic nanoclays may be used. Natural nanoclay such as Cloisite® Na+ and synthetic smectite clays such as Laponite® are available from Southern Clay Products.

The pipes of the present invention are particularly suitable for use in transporting hydrocarbons, including crude oil, natural gas, and petrochemicals. The hydrocarbons may contain water and/or alcohols. One application would be piping for natural gas, including natural gas under high pressure. An additional application would be underground piping used to convey gasoline in service stations. Another application would be piping for use in transporting hydrocarbons in chemical plants. These end use applications serve to illustrate some of the various fields of application for this invention. Numerous other similar applications will occur to one skilled in the art, all of which are included within the spirit of this invention.

The pipes of the present invention have good permeation resistance to major components of gasoline (such as those in ASTM test fluid CM15, which contain 42.5 percent toluene, 42.5 percent iso-octene, and 15 percent methanol), particularly in comparison with common piping materials such as polyethylene. The permeation resistance of pipes can be measured using the method and apparatus described in US patent application publication 2006/0169027, which is hereby incorporated by reference herein.

### EXAMPLES

### Ingredients

The polyamide copolymer used in the examples and comparative examples was prepared in an autoclave using standard polyamide polymerization techniques well known in the art. The copolymer was 75 weight percent polyamide 6,6 and 25 weight percent polyamide 6 and had a melting point of about 210° C. and a relative viscosity of about 166 when measured in formic acid.

“Polyethylene” refers to PE3408 Continuum™ bimodal high density polyethylene available from Dow Chemical Company, Midland, Mich.,

“Nanoclay” refers to Cloisite®30B, a montmorillonite nanoclay modified with a quaternary ammonium salt available from Southern Clay Products, Inc.

“Compatibilizer” refers to Fusabond® E MB-265D a high density polyethylene grafted with maleic anhydride, available from E. I. DuPont de Nemours, Inc., Wilmington, Del.

### Preparation of Nanoclay Dispersion

Polyamide and nanoclay were physically dry-blended in a drum and the resulting mixture was fed to the first (i.e., furthest from the die) barrel of a 57 mm Wemer & Pfleiderer co-rotating twin screw extruder having a barrel temperature of about 220° C. and a die temperature of about 240° C. and operating at a screw speed of about 225 rpm. A vacuum port was used on the extruder. The resulting strand was quenched in water and cut into pellets that were sparged with nitrogen until cool. A first blend (referred to as “PA-NC A”) was prepared from 95 weight percent polyamide and 5 weight percent nanoclay. A second blend (referred to as “PA-NC B”) was prepared from 90 weight percent polyamide and 10 weight percent nanoclay.

### Preparation of Pipes

The pipes of the examples and comparative examples were prepared using conventional pipe-forming equipment. The ingredients (given in Table 1) were conveyed and mixed using a Sterling 2½-inch extruder. The barrel and die temperatures were approximately those indicated in Table 1 and the screw was controlled at about 45 rpm. The extruder was followed by a standard pipe-forming die and a Conair Model MVS3-104 vacuum forming box and Conair Model 6-39 puller. After exiting the puller, the pipe was cut into convenient lengths using a hand held saw and the samples were tested for permeation resistance.

TABLE 1

| | Comp. | Comp. | | |
|---|---|---|---|---|
| | Ex. 1 | Ex. 2 | Ex. 1 | Ex. 2 |
| Polyamide | — | 10 | — | — |
| PA-NC A | — | — | 8.3 | — |
| PA-NC B | — | — | — | 8.3 |
| Polyethylene | 100 | 90 | 90 | 90 |
| Compatibilizer | — | — | 1.7 | 1.7 |
| Extrusion temp. (° C.) | 200 | 180 | 180 | 180 |

Ingredient quantities are given in weight percent based on the total weight of the ingredients.

### Determination of Permeation Rate

The pipe samples obtained as described above were placed in a permeation test apparatus. The apparatus was composed of two aluminum end fixtures connected by tie rods. The end fixtures were of a size that would conveniently provide closure for the pipe test sample. Each of the end fixtures was equipped with a Viton® fluoroelastomer gasket having a 75 durometer hardness to provide a sealing surface against the ends of the pipe test sample.

One of the end fixtures was equipped with a hole to allow introduction of the test fluid. Permeation test fluids were (A) hexane or (B) ASTM test fluid CM15 (containing 42.5 percent, 42.5 percent, and 15% of toluene, iso-octene, and methanol, respectively). Sufficient test fluid was added to each test apparatus such that it was filled about 80 percent and the hole was sealed using a bolt and Viton® gasket. All apparatus were stored in the same location at approximately 23° C.

Each was weighed daily except weekends and holidays. The resulting time vs. weight data were analyzed as follows. It was first noted that initially the weight remained constant for several days. This demonstrates that leakage in the testing device is not occurring. After the initial period of minimal weight loss, weight loss occurred at an increasing daily rate until a constant daily weight loss was observed.

Using a linear regression of the weight data in the constant weight loss period, the steady-state permeation rate was determined. By dividing by the outer surface area and multiplying by the pipe thickness, the permeation rate in gram-mm per square meter per day could be determined.

The pipe dimensions used and permeation measurement results for testing with hexane are given in Table 2 and those for testing with ASTM test fluid CM15 are given in Table 3.

TABLE 2

| | Comp. | Comp. | | |
|---|---|---|---|---|
| | Ex. 1 | Ex. 2 | Ex. 1 | Ex. 2 |
| Pipe length (mm) | 106.2 | 106.8 | 106.7 | 105.8 |
| Pipe diameter (mm) | 50.2 | 51.1 | 51.7 | 49.42 |
| Pipe thickness (mm) | 5.4 | 4.8 | 5.5 | 5.8 |
| Number of days at steady | 91 | 88 | 83 | 83 |
| state weight loss | | | | |
| Total loss of weight during | 8.7 | 2.4 | 2.6 | 1.8 |
| steady state weight loss (g) | | | | |
| Permeation rate | 30.5 | 7.4 | 9.8 | 7.6 |
| (g · mm/m²/day) | | | | |

TABLE 3

| | Comp. | Comp. | | |
|---|---|---|---|---|
| | Ex. 1 | Ex. 2 | Ex. 1 | Ex. 2 |
| Pipe length (mm) | 106.9 | 107.0 | 107.7 | 106.4 |
| Pipe diameter (mm) | 51.5 | 51.8 | 50.5 | 48.8 |
| Pipe thickness (mm) | 4.7 | 4.7 | 4.9 | 5.4 |
| Number of days at steady | 68 | 64 | 56 | 56 |
| state weight loss | | | | |
| Total loss of weight during | 5.2 | 4.9 | 3.7 | 2.7 |
| steady state weight loss (g) | | | | |
| Permeation rate | 16.1 | 15.9 | 13.9 | 11.4 |
| (g · mm/m²/day) | | | | |

What is claimed is:

1. Pipe comprising a composition comprising a melt-mixed blend of:
(a) at least one polyolefin;
(b) at least one polyamide incompatible with said at least one polyolefin (a);
(c) at least one nanoclay exfoliated in the polyamides (b); and
(d) at least one alkylcarboxyl-substituted polyolefin compatibilizer;
wherein the polyolefins (a) are in a continuous matrix phase and the polyamides (b) are present in a discontinuous distributed phase in the form of a multitude of thin, substantially two-dimensional, parallel, and overlapping layers of material embedded in the continuous phase, and where the nanoclays (c) are present in the polyamides (b) and further wherein at least a portion of the compatibilizer (d) is present between said layers and promotes adhesion therebetween.

2. The pipe of claim 1, wherein the polyamide and nanoclay are present in between a ratio of about 95:5 and about 85:15, respectively.

3. The pipe of claim 1, wherein the polyamide and nanoclay are present in between a ratio of about 95:5 and about 90:10, respectively

4. The pipe of claim 1, wherein the melt-mixed blend comprises about 2 to about 40 weight percent of polyamide (b) and nanoclay (c) combined; about 0.25 to about 12 weight percent of compatibilizer (d); and about 59 to about 97.75 weight percent of polyolefin (a), wherein the weight percentages are based on the total amount of (a)+(b)+(c)+(d).

5. The pipe of claim 1, wherein the melt-mixed blend comprises about 3 to about 20 weight percent of polyamide (b) and nanoclay (c) combined; about 0.25 to about 6 weight percent of compatibilizer (d); and about 79 to about 96.75 weight percent of polyolefin (a), wherein the weight percentages are based on the total amount of (a)+(b)+(c)+(d).

6. The pipe of claim 1, wherein the melt-mixed blend comprises about 5 to about 15 weight percent of polyamide (b) and nanoclay (c) combined; about 0.4 to about 4 weight percent of compatibilizer (d); and about 84 to about 94.5 weight percent of polyolefin (a), wherein the weight percentages are based on the total amount of (a)+(b)+(c)+(d)

7. The pipe of claim 1, wherein the polyolefin is polyethylene.

8. The pipe of claim 1, wherein the one or more polyamides have melting points between about 150 and about 250° C.

9. The pipe of claim 1, wherein the compatibilizer is a polyolefin grafted with a dicarboxylic acid and/or dicarboxylic acid derivative.

10. The pipe of claim 1, wherein the nanoclay is at least one smectite clay.

11. The pipe of claim 10, wherein the nanoclay is montmorillonite.

12. The pipe of claim 1 in the form of a natural gas pipe.

13. The pipe of claim 1 in the form of a gasoline service station pipe.

14. A method for forming pipes, comprising the steps of
(i) exfoliating (a) least one nanoclay in (b) at least one polyamide to form blend A;
(ii) melt-blending (c) at least one polyolefin, (d) at least one alkylcarboxyl-substituted polyolefin compatibilizer; and blend A to form melt blend B;
(iii) extruding melt blend B into a molten extrudate having the form of a pipe such that the extrudate is not substantially stretched; and
(iv) cooling the extrudate sufficiently to allow it to solidify into a pipe,
wherein the solidified extrudate is not substantially stretched, and such that in the pipe the polyolefins (c) are in a continuous matrix phase and the polyamides (b) are present in a discontinuous distributed phase in the form of a multitude of thin, substantially two-dimensional, parallel, and overlapping layers of material embedded in the continuous phase, and where the nanoclays (a) are present in the polyamides (b) and further wherein at least a portion of the compatibilizer (d) is present between said layers and promotes adhesion therebetween.

15. The method of claim 14, wherein the polyamide (b) and nanoclay (a) are present in between a ratio of about 95:5 and about 85:15, respectively.

16. The method of claim 14, wherein the polyolefin is polyethylene.

17. The method of claim 14, wherein the compatibilizer is a polyolefin grafted with a dicarboxylic acid and/or dicarboxylic acid derivative.

18. The method of claim 14, wherein the is at least one smectite clay.

19. The method of claim 18, wherein the smectite clay is montmorillonite.
